(19) United States
(12) Patent Application Publication
(10) Pub. No.: US 2007/0296126 A1
(43) Pub. Date: Dec. 27, 2007

(54) Reusable silicone vacuum bag/tool flange sealing method

(76) Inventor: Lawrence F. Audette, Hutto, TX (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/471,906

(22) Filed: Jun. 21, 2006

(51) Int. Cl. B29C 43/10

(52) U.S. Cl. 264/571

(57) ABSTRACT

An improvement to a process for making plastic parts in infusion processes using a reusable polymer soft flexible bag, wherein the bag is sealed directly to the tool flange portion using an interlocking press sealing device. The interlocking device has one mating portion bonded to the tool flange and the other mating portion either bonded to the bag or integrally assimilated into the bag during its manufacture by spraying or swirl spraying one or more multiple layers or coats of a polymer made from one or plural component polymer material, such as that described in U.S. Pat. No. 7,014,809 dated Mar. 21, 2006. Alternative seals include seals made from material suitable for providing a breathable seal against composite materials allow for the passage of air through or underneath a resultant seal during the infusion process. Seals can also be used between soft bags.

### FIELD OF THE INVENTION

The invention relates to a method of sealing a reusable soft flexible polymer bag or skin to a contact mold flange, or to other media or to itself where the bag may be made utilizing a spray or swirl spray application of a sprayable polymer and is used as a bagging material to allow for the creation of vacuum, pressure or cycles of both within the “skin to contact mold” envelope created by the seals. The envelope created by this sealing mechanism can be used in a variety of processes for making plastic parts including but not limited to a resin transfer process (infusion or vacuum bagging process) for making polymer parts, such as fiberglass reinforced plastic parts.

### BACKGROUND OF THE INVENTION

Using a soft flexible bag together with a contact mold in the infusion or vacuum bagging process is known in the art. Part of the process requires the establishment of a seal to the bag to the contact mold so that vacuum and or pressure can be established within the area of the seal. One such method of sealing is described in U.S. Pat. No. 5,665,301 dated Sep. 9, 1997, to Alanko, where as shown in FIG. 3 of the patent, Alanko discloses the creation of a “vacuum chamber” assembly by use of rubber seals attached to the under side surface of a planar fiber reinforced composite or equivalent sheet which when in contact with a mold flange forms the “vacuum chamber”. The need to fabricate this accessory composite vacuum chamber can be difficult and cumbersome to handle, requires additional accessory component fabrication, and the seal is difficult to implement. The difficulty of requiring a planar fiber reinforced composite component to create the vacuum chamber adds additional burden and costs to the manufacturing process of the end use part to be made.

In addition, U.S. Pat. No. 5,665,301 to Alanko discusses the use of a unitary reusable vacuum bag and the advantages of a reusable bag over single use bags. This patent also makes reference to U.S. Pat. No. 5,316,462 to Seemann and U.S. Pat. No. 5,087,193 to Hebert, wherein both refer to the use of polymers (in this case silicone) to create multi-use reusable bags, but both also have significant drawbacks due to the large amounts of labor requirements in making the bags and in adapting the bag to different geometries associated with the infusion process.

What is needed is a way to eliminate the reinforced composite ring necessary to create the vacuum chamber and integrate the seal directly into the bag to facilitate a less cumbersome positive sealing method which would be easier to handle, quicker to install and which would provide a simpler method to produce and a more reliable sealing method.

### SUMMARY OF THE INVENTION

One such method to lower the cost of the manufacturing process is to make a reusable soft flexible polymer bag or skin which would integrate the seal or seals into the bag and as such, seal directly to a tool flange eliminating the requirement to use a planar fiber reinforced composite or equilavent sheet to create the seal, where the bag is made utilizing a spray or swirl spray application of a sprayable polymer and is used as a bagging material to be used in vacuum or pressure process (infusion or vacuum bagging process) for making polymer parts, such as fiberglass reinforced plastic parts.

This sprayable process is described in U.S. Pat. No. 7,014,809 dated Mar. 21, 2006 to the inventor herein and entitled “PROCESS FOR MAKING A REUSABLE SOFT BAG FOR USE IN INFUSION PROCESSES FOR MAKING PLASTIC PARTS,” which is incorporated by reference herein in its totality in lieu of restating its contents herein. However, the present invention is not limited to the marine industry but may be used in any industry where a reusable soft bag is used with a contact tool for the purposes of making a plastic part. The invention of a spray made reusable polymer vacuum bag was created to meet the needs for reducing the costs associated with resin infusion or closed mold processes found in the reinforced or composite markets. Current art documents the use of disposable materials in the creation of one part. The costs associated with non reusable materials make the use of the materials impossible.

As noted in U.S. Pat. No. 7,014,809, resin ports, or vacuum ports can be included or formed in during the spray process. What is proposed herein is the inclusion of a re-sealable closure means, wherein the closure means can be molded, modeled or adhesively added to the manufactured reusable bag following the bags construction or molded, or modeled into the bag during the bag construction process and the closure means can be adapted to provide a seal against the flange of the contact mold or hard tool which would create the seal to the outer parameter of the bag. When required an inner perimeter or concentric seal could be added in a similar fashion. The inner seal, if required would complete the vacuum envelope, would not necessarily seal against the contact mold, but rather seal against the schedule of materials within the vacuum envelope.

For reusable soft bags made by methods other than that described in U.S. Pat. No. 7,014,809, the outer re-sealable closure means can be molded, modeled or adhesively applied or bonded to the soft bag.

The configuration comprising the outer re-sealable closure means can be configured in a variety of profiles including but not limited to interlocking profiles similar to the tongue and groove sealing mechanisms as found in plastic polyethylene bags such as those made by Glad® bag or slightly large tongue and groove type of closure means such those found in food containers. Other closure means that could be used are closures similar in style to those made by companies such as Zip-Lock® bags. The tongue and groove type of closure means require only the pressing and sealing together of the mating parts around the hard tool flange, wherein the lower mating portion would be attached to the flange of the contact mold and would be made from material suitable to provide a seal against the flange of the contact mold or hard tool. The opposing interlocking device would be molded, modeled, or adhesively bonded to the under side of the bag. An inner perimeter or concentric seal, where required, could also be molded, modeled, or adhesively attached to the bag such that the inner concentric seal would allow for pressure or vacuum to pass beneath the seal during an initiated process such as resin infusion. The inner seal could be constructed such that it would allow for passage or leakage underneath the seal and would not be of the press and seal variety but would still be bonded, molded or modeled to the underside of the reusable bag.

Other closure means between the soft bag and the flange of the hard tool may also include a seal such as, but not limited to, a rubberized material that can be pressed against the flange. This type of seal is described in U.S. Pat. No. 5,665,301 mentioned above; however, in this reference, the seal is not being used between the soft bag and the hard tool flange, but is rather used according to the prior art between the bag and a clamping assembly in one instance and between the clamping assembly and the hard tool flange in the other instance. Also, the seal would preferably be bonded to the soft bag side. The profile of the seal could be V-shaped as depicted in the drawings described below, round shaped, square shaped, or wedge shaped and molded or modeled or bonded to the soft bag. Effectively, the outer seal must have a profile that allows a perimeter vacuum or pressure seal. The inner perimeter seal need only be attached to the underside of the soft bag. Stand-offs or offsets, which are typically molded, modeled or adhesively bonded, may be optionally added between the inner and outer seal to facilitate vacuum movement throughout the area between the seals. In this invention, if necessary, the vacuum port could alternately be installed in the contact mold flange between the inner and outer seals.

With either type of seal closure means used in the present invention as described above, when the infusion process is over, the bag can be removed with the closure means remaining attached to the bag.

In still another embodiment, the invention contemplates the use of closure means between two or more soft bags assembled where one sealed larger bag is desired. Again, the closure means can be the press and seal configuration or the seal of various profiles with materials used in the trade such as, but not limited to, a rubberized material such as that described above. This embodiment is very beneficial for the following reason, among others. There exists tremendous obstacles in the use of, installation, removal, and storage of large polymer reusable vacuum bags. While equipment exists which is capable of lifting large amounts of weight, the polymer bags themselves do not have enough internal strength to allow them to be lifted without the probability of tearing or failing. Large bags create logistical problems for installation over a laminate schedule where the weight of such a large bag could cause the laminate schedule already in place to shift under the pick and place movement of a large single piece bag. Removal of the bag after the process is complete and storage when the bag is not required as part of the process, also creates significant obstacles in using a large single part bag. A single part requiring a bag which is 20 feet long by 10 feet wide would alone would weigh almost 500 pounds. Large applications could require bags which could easily exceed 60 feet in length by 30 feet wide.

### BRIEF DESCRIPTION OF THE DRAWINGS

In the accompanying drawings:

FIG. 1a is a conceptual depiction of the invention where an example of the closure means depicted is the use of V-shaped seals bonded to the soft bag;

FIG. 1b is a conceptual depiction of the present invention depicting a combination of a V-shaped seal with a press and seal channel type of seal as an alternative to FIG. 1a;

FIG. 1c is a conceptual depiction of the present invention depicting a combination of a concentric inner seal used with a laminate schedule and an optional offset between the bag and the contact tool as well as an outer perimeter seal; and

FIG. 2 is a conceptual depiction of the a plurality of smaller soft bags being used with a plurality of other soft bags (upper bag) with an example of a press and seal channel type of seal being used between the bags.

### DETAILED DESCRIPTION OF THE INVENTION

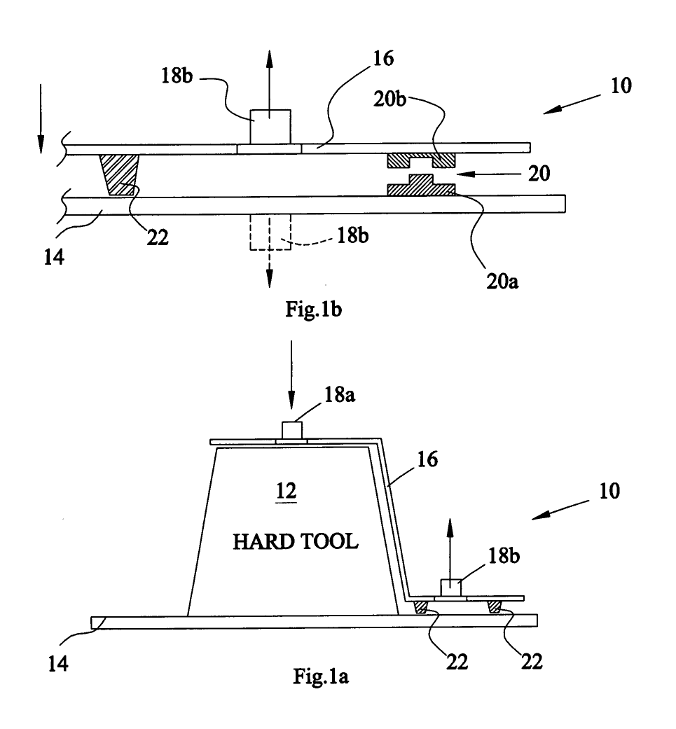

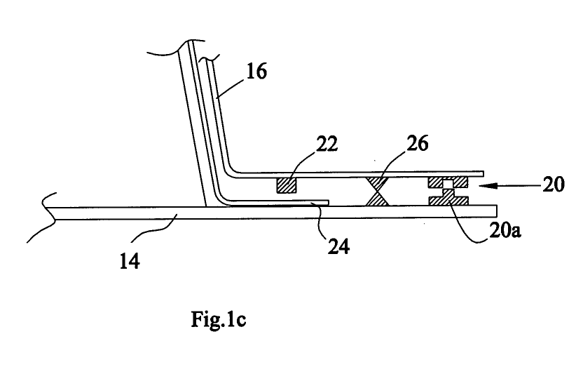

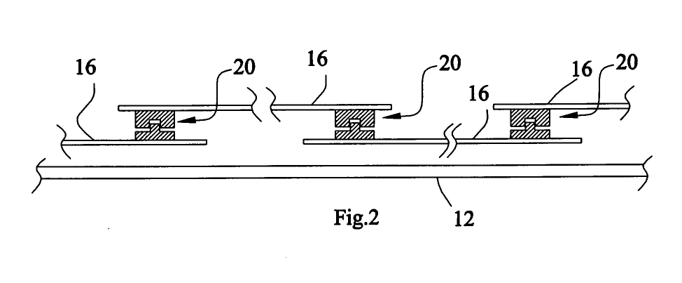

Referring now to the drawings, FIGS. 1a-1c and 2 disclose a conceptual depiction of the present invention, which is a re-usable silicone vacuum bag/tool flange sealing method or smaller bag to smaller bag sealing method to create a larger bag, and is depicted generally as 10.

In one embodiment of the invention, the inventive method is used with a reusable silicone vacuum bag 16 and a hard tool 12 to make a plastic part (not shown). More particularly, the invention comprises closure means 20 between the flange 14 of the hard tool 12 and the vacuum bag 16 for sealing a perimeter of the vacuum bag 16 to the flange tool 12 before initiating an infusion process.

In the embodiment using a press and seal channel type of closure means, a first mating portion 20a of the closure means 20 is attached to the tool flange 14 and is engagable with a corresponding second mating portion 20b of the closure means 20, which in turn is attached to the vacuum bag 16. The closure means 20 is re-sealable for multiple uses. This type of press and seal closure means is preferably used as the outer perimeter seal as shown in FIG. 1b or FIG. 1c. The second mating portion 20b of the closure means 20 attached to the vacuum bag 16 is adhesively bonded to the vacuum bag 16.

When the vacuum bag 16 is made by spraying or swirl spraying one or more coats of a polymer material made from one or plural component polymer on a surface of an opposing mold serving as a pattern from which the formed bag 16 is configured in accordance with the process described in U.S. Pat. No. 7,014,809, successive coats of the sprayable polymer material are applied once a previously applied coat becomes sufficiently tack-free so as to not cause tearing of the previously applied coat during the spraying of the successive coat. Resin inlet ports 18a and vacuum ports 18b are inserted where desired, and the sprayed polymer material is cured when a desired number of the one or more coats of the polymer material are applied thereby forming the soft reusable flexible bag 16, which is then used in conjunction with a more rigid mold or other manufacturing aid to make a desired part.

When the bag 16 is made using the above described spraying process, the second mating portion 20b of the closure means 20 along the perimeter portion of the vacuum bag 16 may be inserted during the spraying process, wherein the second mating portion 20b is thereby integrated, molded or modeled into the vacuum bag 16.

Typically, an inner seal 22 is also used in the process and although FIGS. 1a-1b depict this seal as a V-shaped profile seal as described in the summary of the invention above and FIG. 1c depicts this seal 22 as a relatively square profile. The inner seal 22 will not be of the tongue and groove configuration. The inner seal 22 will still be bonded molded or modeled to the underside of the bag 16, but in this case, the inner seal 22 will seal against the contact mold flange 14 or a laminate schedule or other media 24 within or against the contact mold 12 and flange 14, yet will allow for passage of air or resin or both between the seal into the area of greatest vacuum. This inner seal 22 can be bonded, molded, or modeled to complete its attachment to the bag. FIG. 1a depicts the use of the V-shaped seal 22 in both the outer perimeter position as well as inward of the vacuum ports 18b. Further, as depicted in FIG. 1b, the vacuum port 18b may alternatively be located on the flange 14 (Vacuum port 18b is shown in phantom in this case).

The closure means 20 between the flange 14 of the hard tool 12 and the vacuum bag 16 for sealing the perimeter portion of the vacuum bag 16 to the flange tool 12 before initiating the infusion process comprises, in one preferred embodiment, a tongue and groove press sealing connection or as mentioned above, also called a press and seal channel type of seal system between the hard tool flange 14 and the soft bag 16. This type of connection is well known in the food container or food bag industry.

The drawings are intended to show merely examples of inner and outer seal configurations. The inventive process comprises the use of seals attached to the soft bag where the inner seal engage with the components in the contact tool 14 to provide a seal as discussed above.

When desired or needed, an stand-offs or offsets 26, which are typically molded, modeled or adhesively bonded, may be optionally added between the inner and outer seal 22,20 to facilitate vacuum movement throughout the area between the seals.

FIG. 2 conceptually depicts the use of a plurality of channel types of seals or closure means 20 attached to a bag 16 for use with other soft bags 16 to make smaller components of a larger product to be made or to make a larger bag for such applications as a hull of a boat.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A reusable polymer vacuum bag/tool flange sealing method for use in infusion or vacuum bag processes to be used in the manufacturing of plastic parts comprising:
providing a reusable polymer vacuum bag and a hard tool to make a plastic part;
providing a vacuum port in the reusable polymer vacuum bag or in a flange of the hard tool; and
providing spaced-apart outer and inner closure means between a flange of the hard tool and the vacuum bag for sealing an outer perimeter portion of the vacuum bag to the flange tool and having the inner closure means pressing against the flange tool or against a laminate schedule in the tool before initiating a vacuum process, the vacuum port being located between said outer and inner closure means;
wherein the outer closure means is molded, modeled or adhesively bonded to the vacuum bag and is further made from material suitable for providing an airtight seal against the flange of the hard tool during the process,
wherein the inner closure means is molded, modeled or adhesively bonded to the vacuum bag and is further adapted to allow for a sufficient vacuum, resin or both to be pulled beneath the inner closure means's seal against the hard tool flange or schedule and as such would allow and facilitate the drawing of air or a resinous product between said vacuum bag and said hard tool during the infusion process, and
wherein said outer and inner closure means are capable of multiple uses.

2. The method according to claim 1, wherein the polymer vacuum bag is made by spraying or swirl spraying one or more coats of a polymer material made from one or plural component polymer on a surface of an opposing mold serving as a pattern from which the formed bag is configured, wherein successive coats of the sprayable silicone material are applied once a previously applied coat becomes sufficiently tack-free so as to not cause tearing of the previously applied coat during the spraying of the successive coat, inserting of resin ports and vacuum ports where desired; and curing said sprayed silicone material when a desired number of the one or more coats of the silicone material are applied; wherein the cured formed soft reusable flexible polymer vacuum bag is configured so as to be used in conjunction with a more rigid mold or other manufacturing aid to make a desired part.

3. The method according to claim 2, wherein said closure means is integrated into said polymer vacuum bag during the spraying process.

4. The method according to claim 1, wherein the outer closure means between the flange of the hard tool and the polymer vacuum bag comprises a tongue and groove press sealing connection, wherein a bottom mating half of said tongue and groove press sealing connection is bonded to the flange or a single part seal configured and capable of creating an adequate outer seal wherein said single part outer seal is modeled molded or adhesively bonded to the polymer vacuum bag yet lies between the hard tool flange and the polymer vacuum bag.

5. The method according to claim 1, wherein the inner and outer closure means comprises a seal configured with a desired profile.

6. The method according to claim 1, further comprising:
providing offset means between the polymer vacuum bag and the flange of the hard tool, said offset means being located between the spaced-apart outer and inner closure means.

7. A reusable polymer vacuum bag sealing method for use in infusion or vacuum bag processes to be used in the manufacturing of various size plastic parts comprising:
providing a plurality of soft bag segments, wherein each soft bag segment overlaps an adjacent soft bag segment to form an overlap portion;
providing closure means between adjacent soft bag segments at the overlap portion, wherein respective mating portions of the closure means are molded, modeled or adhesively bonded to respective sides of the soft bag segments to be joined; and joining or
installing the plurality of soft bag segments for the creation of a larger unified bag for use in allowing the creation of a vacuum to be used in making the desired plastic part using an infusion or vacuum bag process,
wherein said closure means are capable of multiple uses.

8. The method according to claim 7, wherein the closure means between each of the plurality of soft bag segments comprises a tongue and groove press sealing connection.
